(19) United States
(12) Patent Application Publication
(10) Pub. No.: US 2021/0400956 A1
(43) Pub. Date: Dec. 30, 2021

(54) CORE-SHELL COMPOSITE AND A PROCESS OF PREPARING THE SAME

(71) Applicant: AGENCY FOR SCIENCE, TECHNOLOGY AND RESEARCH, Singapore (SG)

(72) Inventors: Yugen Zhang, Singapore (SG); Siti Nurhanna Binte Riduan, Singapore (SG)

(21) Appl. No.: 17/281,312

(22) PCT Filed: Sep. 24, 2019
(86) PCT No.: PCT/SG2019/050486

§ 371 Date: Mar. 30, 2021

(30) Foreign Application Priority Data
Oct. 5, 2018 (SG) 10201808838P

(51) Int. Cl. A01N 25/26; C09D 5/14; C09D 7/40; C09D 7/62; C09C 1/04; C09C 3/06; A01N 59/16

(52) U.S. Cl. CPC A01N 25/26; C09D 5/14; C09D 7/70; C01P 2004/80; C09C 1/04; C09C 3/063; A01N 59/16; C09D 7/62

(57) ABSTRACT

There is provided a core-shell composite comprising a core which comprises zinc metal and a shell that at least partially encapsulates the core, wherein the shell comprises a salt of the zinc metal as a cation with a sulphur-containing anion. There is also provided a method of forming a core-shell composite comprising the step of heating a mixture of zinc metal particle with elemental sulphur to form the core-shell composite, wherein the zinc metal particle forms the core of the core-shell composite, and wherein the shell of the said core-shell composite at least partially encapsulates the core and comprises a salt of the zinc metal as a cation with a sulphur-containing anion. There is also provided a method of killing or inhibiting the growth of a microbe, comprising the step of subjecting the microbe to the as-disclosed core-shell composite. There is also provided an anti-microbial coating on a substrate surface or an additive in a composition or a formulation comprising the as-disclosed core-shell composite.

### REFERENCES TO RELATED APPLICATIONS

This application claims priority to Singapore application number 10201808838P filed on 5 Oct. 2018, the disclosure of which is hereby incorporated by reference.

### TECHNICAL FIELD

The present invention relates to a core-shell composite and a process of preparing the same.

### BACKGROUND ART

Microbial infections and the development of antimicrobial resistance have received attention as one of the most critical issues facing the public health and security. The creation of clean antimicrobial surfaces with long-term stabilities and activities have tremendous applications involving almost all aspects of daily life, such as medical devices, hospital surfaces, textiles, packaging, electrical appliances, marine antifouling, filters and public surfaces.

Inorganic antimicrobial materials, especially semiconductor antimicrobial materials are less prone to chemical contamination and possess long-term stability. When these semiconductor materials are synthesized using two or more materials and multilayers result, a core-shell type material is formed, often with core-shell particles showing distinctive properties of the materials employed together. The physiochemical and structural properties of materials including particle size and concentration, morphology, presence of surface charges and conductivity, can affect their antimicrobial activity and toxicity mechanisms. Some metal or metal oxides, such as silver, zinc oxide and titanium oxide materials have been used as antimicrobial ingredients in various products or in antimicrobial surface coatings. However, these materials have various limitations, such as heavy metal contamination/toxicity for silver-based materials and low antimicrobial efficacies due to dependence on photo irradiation and uncertain nano-toxicity for zinc oxide and titanium oxide materials.

Therefore, there is a need to provide a process and a core-shell material for antimicrobial activity that overcome or ameliorate one or more of the disadvantages mentioned above.

### SUMMARY

In one aspect, the present disclosure relates to a core-shell composite comprising a core comprising a zinc metal, and a shell that at least partially encapsulates the core, wherein the shell comprises a salt of the zinc metal as a cation with a sulphur-containing anion.

Advantageously, the core-shell composite formed in the present disclosure may be able to release reactive oxygen species without the need for activation by ultraviolet or visible light irradiation.

Further advantageously, the core-shell composite may demonstrate an antimicrobial activity in the form of antibacterial and antifungal effects. Thus, the core-shell composite can be used as an antimicrobial additive to be mixed in other systems or as part of an antimicrobial surface coating.

In another aspect, the present disclosure relates to a method of forming a core-shell composite comprising the step of heating a mixture of zinc metal particle with elemental sulphur to form said core-shell composite, wherein the zinc metal particle forms the core of the core-shell composite, and wherein the shell of the core-shell composite at least partially encapsulates said core and comprises a salt of the zinc metal as a cation with a sulphur-containing anion.

Advantageously, the core-shell composite formed in the present disclosure may be stable and easily synthesized, thus enabling scale-up in manufacturing.

In another aspect, the present disclosure relates to a method of killing or inhibiting the growth of a microbe, comprising the step of subjecting the microbe to a core-shell composite, wherein the core-shell composite comprises a core comprising zinc metal and a shell that at least partially encapsulates the core, wherein the shell comprises a salt of the zinc metal as a cation with a sulphur-containing anion.

In another aspect, the present disclosure relates to the use of a core-shell composite as an anti-microbial coating on a substrate surface, wherein the core-shell composite comprises a core comprising a zinc metal, and a shell that at least partially encapsulates the core, wherein the shell comprises a salt of the zinc metal as a cation with a sulphur-containing anion.

In another aspect, the present disclosure relates to the use of a core-shell composite as an additive in a composition or a formulation, wherein the core-shell composite comprises a core comprising zinc metal, and a shell that at least partially encapsulates the core, wherein the shell comprises a salt of the zinc metal as a cation with a sulphur-containing anion.

Advantageously, the core-shell composite formed in the present disclosure may be highly active against gram-positive and gram-negative bacteria and fungi without the need for activation by ultraviolet or visible light irradiation.

### Definitions

The following words and terms used herein shall have the meaning indicated:

The term “core-shell” as used herein refers to the structural form comprising of a core of inner material and external shell of one or more layers of material.

The term “composite” as used herein refers to a material made of two or more constituent components that are of different physical and/or chemical properties such that when combined, the resulting material has characteristics different from the constituent components and the individual components remain separate and distinct within the finished structure.

The term “antimicrobial” as used herein refers to causing cell inhibition, cell injury or cell death of target bacteria and fungi microorganisms.

The term “additive” as used herein refers to a substance that is added to another substance or product in minor quantities to impart or improve certain desired performance properties.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a core-shell composite will now be disclosed.

The core-shell composite comprises a core which comprises zinc metal, and a shell that at least partially encapsulates the core, wherein the shell comprises a salt of the zinc metal as a cation with a sulphur-containing anion.

The sulphur-containing anion may possess the formula [SₓO₁₋ₓ]^{y-}, where 0<x≤1 and y is 1 or 2.

The shell may further comprise a plurality of layers, wherein each layer independently comprises said salt of said zinc metal as a cation with a sulphur-containing anion.

Where the core-shell composite is a Zn/ZnS composite, the ZnS shell may be thin and mainly amorphous. The Zn/ZnS composite may be in the size range of about 0.1 to about 200 μm, 0.5 to about 200 μm, 0.8 to about 200 μm, 1 to about 200 μm, 5 to about 200 μm, 8 to about 200 μm, 10 to about 200 μm, 20 to about 200 μm, 50 to about 200 μm, 80 to about 200 μm, 100 to about 200 μm, 150 to about 200 μm, 180 to about 200 μm, 0.1 to about 0.5 μm, 0.1 to about 0.8 μm, 0.1 to about 1 μm, 0.1 to about 5 μm, 0.1 to about 8 μm, 0.1 to about 10 μm, 0.1 to about 50 μm, 0.1 to about 80 μm, 0.1 to about 100 μm, 0.1 to about 150 μm, 0.1 to about 180 μm, 0.5 to about 0.8 μm, 0.5 to about 1 μm, 0.5 to about 5 μm, 0.5 to about 8 μm, 0.5 to about 10 μm, 0.5 to about 50 μm, 0.5 to about 80 μm, 0.5 to about 100 μm, 0.5 to about 150 μm, 0.5 to about 180 μm, 0.8 to about 1 μm, 0.8 to about 5 μm, 0.8 to about 8 μm, 0.8 to about 10 μm, 0.8 to about 50 μm, 0.8 to about 80 μm, 0.8 to about 100 μm, 0.8 to about 150 μm, 0.8 to about 180 μm, 1 to about 5 μm, 1 to about 8 μm, 1 to about 10 μm, 1 to about 50 μm, 1 to about 80 μm, 1 to about 100 μm, 1 to about 150 μm, 1 to about 180 μm, 5 to about 8 μm, 5 to about 10 μm, 5 to about 50 μm, 5 to about 80 μm, 5 to about 100 μm, 5 to about 150 μm, 5 to about 180 μm, 8 to about 10 μm, 8 to about 50 μm, 8 to about 80 μm, 8 to about 100 μm, 8 to about 150 μm, 8 to about 180 μm, 10 to about 50 μm, 10 to about 80 μm, 10 to about 100 μm, 10 to about 150 μm, 10 to about 180 μm, 50 to about 80 μm, 50 to about 100 μm, 50 to about 150 μm, 50 to about 180 μm, 80 to about 100 μm, 80 to about 150 μm, 80 to about 180 μm, 100 to about 150 μm, 100 to about 180 μm, or 150 to about 180 μm.

When the core-shell composite is a Zn/ZnSₓO₁₋ₓ composite, where 0<x<1, the ZnSₓO₁₋ₓ shell may be mainly amorphous.

When the core-shell composite is Zn/ZnS or Zn/ZnSₓO₁₋ₓ, where 0<x<1, the core-shell composite may release reactive oxygen species such as, but not limited to, superoxide radical O₂⁻, without the need for activation by ultraviolet or visible light irradiation. The concentration of the superoxide radical released may be in the range of about 1 mM to about 10 mM, for every 10 mg of said core-shell composite.

When the core-shell composite is Zn/ZnS or Zn/ZnSₓO₁₋ₓ, where 0<x<1, the core-shell composite may exhibit antimicrobial activity against microorganisms including, but not limited to, gram-negative bacteria, gram-positive bacteria and fungi. The log reduction of the microorganism population may be in the order of 5.

Exemplary, non-limiting embodiments of a process of preparing a core-shell material will now be disclosed.

The method of forming core-shell composite comprises the step of heating a mixture of zinc metal particle with elemental sulphur to form said core-shell composite, wherein the zinc metal particle forms the core of the core-shell composite, and wherein the shell of the core-shell composite at least partially encapsulates the core and comprises a salt of the zinc metal as a cation with a sulphur-containing anion.

The concentration of the elemental sulphur used may be in the range of about 0.01 to about 20% by weight, about 0.02 to about 20% by weight, about 0.05 to about 20% by weight, about 0.08 to about 20% by weight, about 0.1 to about 20% by weight, about 0.2 to about 20% by weight, about 0.5 to about 20% by weight, about 0.8 to about 20% by weight, about 1 to about 20% by weight, about 2 to about 20% by weight, about 5 to about 20% by weight, about 8 to about 20% by weight, about 10 to about 20% by weight, about 12 to about 20% by weight, about 15 to about 20% by weight, about 18 to about 20% by weight, about 0.01 to about 0.1% by weight, about 0.02 to about 0.1% by weight, about 0.05 to about 0.1% by weight, about 0.08 to about 0.1% by weight, about 0.01 to about 1% by weight, about 0.02 to about 1% by weight, about 0.05 to about 1% by weight, about 0.08 to about 1% by weight, about 0.1 to about 1% by weight, about 0.01 to about 10% by weight, about 0.02 to about 10% by weight, about 0.05 to about 10% by weight, about 0.08 to about 10% by weight, about 0.1 to about 1% by weight, about 0.2 to about 1% by weight, about 0.5 to about 1% by weight, about 0.8 to about 1% by weight, about 0.2 to about 10% by weight, about 0.5 to about 10% by weight, about 0.8 to about 10% by weight or about 1 to about 10% by weight.

The heating of the mixture may be undertaken at a temperature in the range of about 100 to about 160° C., about 110 to about 160° C., about 120 to about 160° C., about 130 to about 160° C., about 140 to about 160° C., about 150 to about 160° C., about 100 to about 150° C., about 100 to about 140° C., about 100 to about 130° C., about 100 to about 120° C., about 100 to about 110° C., about 110 to about 150° C., about 110 to about 140° C., about 110 to about 130° C., about 110 to about 120° C., about 120 to about 130° C., about 130 to about 140° C., or about 140 to about 150° C.

The heating of the mixture may be undertaken for a period of time in the range of about 1 to about 10 hours, about 2 to about 10 hours, about 5 to about 10 hours, about 8 to about 10 hours, about 1 to about 8 hours, about 1 to about 5 hours, about 1 to about 2 hours, about 2 to about 8 hours, about 2 to about 5 hours, or about 5 to about 8 hours.

The method may further comprise the step of reacting the core-shell composite with an aqueous solution.

When the method further includes the step of reacting the core-shell composite with an aqueous solution, the step may be undertaken at a temperature in the range of about 90 to about 110° C., 95 to about 110° C., 100 to about 110° C., 105 to about 110° C., 90 to about 105° C., 90 to about 100° C., 90 to about 95° C., 95 to about 105° C., 95 to about 100° C., or 100 to about 105° C.

When the method further includes the step of reacting the core-shell composite with an aqueous solution, the step may be undertaken for a period of time in the range of about 1 to about 10 hours, about 2 to about 10 hours, about 5 to about 10 hours, about 8 to about 10 hours, about 1 to about 8 hours, about 1 to about 5 hours, about 1 to about 2 hours, about 2 to about 8 hours, about 2 to about 5 hours, or about 5 to about 8 hours.

The method may further comprise the step of, before the reacting step between core-shell composite and aqueous solution, cooling the core-shell composite to a temperature, for example but not limited to, about 100° C. Any other temperatures can be used as long as they provide a cooling effect.

The aqueous solution may be water.

There is also provided a method of killing or inhibiting the growth of a microbe, the method comprising the step of subjecting the microbe to a core-shell composite, wherein the core-shell composite comprises a core comprising zinc metal, and a shell that at least partially encapsulates the core, wherein the shell comprises a salt of the zinc metal as a cation with a sulphur-containing anion.

The core-shell composite may be applied as a coating on a substrate surface.

The core-shell composite may be applied as an additive in a composition or a formulation.

When the core-shell composite is added as an additive to a composition or a formulation, the composition or formulation may be non-therapeutic.

There is also provided use of a core-shell composite as an antimicrobial coating on a substrate surface, wherein the core-shell composite comprises a core comprising zinc metal, and a shell that at least partially encapsulates the core, wherein the shell comprises a salt of the zinc metal as a cation with a sulphur-containing anion.

There is also provided use of a core-shell composite as an additive in a composition or a formulation, wherein the core-shell composite comprises a core comprising zinc metal, and a shell that at least partially encapsulates the core, wherein the shell comprises a salt of the zinc metal as a cation with a sulphur-containing anion.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1A is a scanning electron microscopy (SEM) image of Zn/ZnS composite (magnification of ×7500, and scale bar of 1 μm) made in accordance to the synthesis process in Example 1.

FIG. 1B is a scanning electron microscopy-energy dispersive X-ray (SEM-EDX) elemental mapping (Zn) image of Zn/ZnS composite (scale bar of 5 μm) made in accordance to the synthesis process in Example 1.

FIG. 1C is a SEM-EDX elemental mapping (S) image of Zn/ZnS composite (scale bar of 5 μm) made in accordance to the synthesis process in Example 1.

FIG. 2A is a SEM image of Zn/ZnSₓO₁₋ₓ composite (scale bar of 5 μm) made in accordance to the synthesis process in Example 2.

FIG. 2B is a SEM-EDX elemental mapping (Zn) image Zn/ZnSₓO₁₋ₓ composite (scale bar of 5 μm) made in accordance to the synthesis process in Example 2.

FIG. 2C is a SEM-EDX elemental mapping (O) image Zn/ZnSₓO₁₋ₓ composite (scale bar of 5 μm) made in accordance to the synthesis process in Example 2.

FIG. 2D is a SEM-EDX elemental mapping (S) image Zn/ZnSₓO₁₋ₓ composite (scale bar of 5 μm) made in accordance to the synthesis process in Example 2.

FIG. 3 is a X-ray powder diffraction (XRD) spectra of elemental sulphur, Zn/ZnSₓO₁₋ₓ (II), Zn/ZnS, ZnO, Zn and Zn/ZnSₓO₁₋ₓ (I) particles as characterized in Example 3.

FIG. 4 is a UV-vis spectra of Zn/ZnSₓO₁₋ₓ (I), Zn/ZnSₓO₁₋ₓ (II) and Zn/ZnS particles as characterized in Example 3.

FIG. 5 is a bar graph showing absorbance values at wavelength 470 nm for the soluble reduced product formazan of the tetrazolium dye XTT corresponding to the superoxide radical released for the various synthesized core-shell composites and the blank sample which is a control composed of XTT solution only. All data is expressed as mean (±standard deviation) of three replicates.

### EXAMPLES

Non-limiting examples of the invention and a comparative example will be further described in greater detail by reference to specific Examples, which should not be construed as in any way limiting the scope of the invention.

### Materials and Methods

All the reagents were obtained from commercial suppliers and used without further purification. Commercially available Zn powder of 1 μm to 10 μm particle size and sulphur were purchased from Sigma-Aldrich (of St Louis, Mo. of the United States of America). Samples such as the various synthesized core-shell composites were subjected to imaging using the scanning electron microscope-energy dispersive X-ray (SEM-EDX) (model JEOL JSM-7400F) at an accelerating voltage of 5 keV. Prior to SEM imaging, the samples were sputter-coated with platinum using the Auto Fine Coater (model JEOL JFC-1600). Further characterizations of the samples were done using the X-ray powder diffraction (XRD) and UV-vis spectroscopy. Samples were pressed onto a sample holder and powder XRD analysis was performed using a Bruker D8 Advance system equipped with Cu Kα radiation (λ=1.5406 Á̊). UV-vis spectra were collected using a Shimadzu UV-Vis-NIR spectrophotometer (model UV-3600), equipped with an integrating sphere attachment.

### Example 1: Synthesis of Zn/ZnS Core-Shell Composite

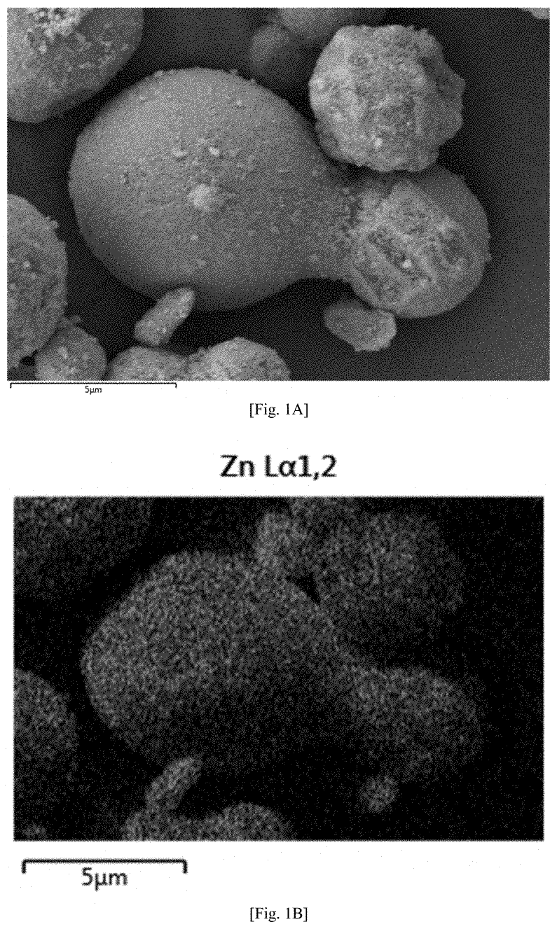

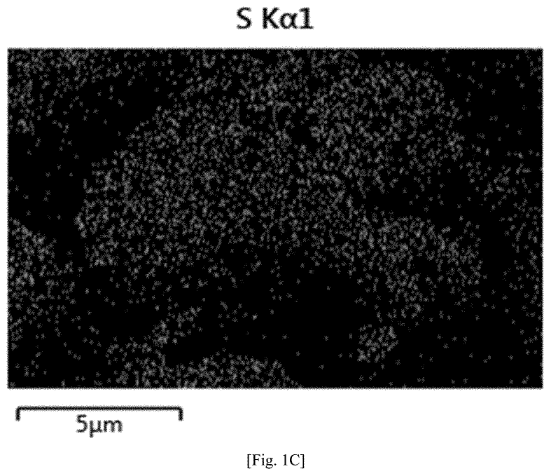

Zn/ZnS core-shell composite was prepared by direct reaction between zinc powder and elemental sulphur. Fresh zinc powder was mixed with sulphur (0.01 to 20% by weight) and grounded by hand for 10 minutes. The mixture was subsequently heated at a constant temperature between 100 to 160° C. for 1 to 10 hours. Zn/ZnS composite was obtained after cooling to room temperature (which is about 25° C.). From FIG. 1A, a deposited layer of ZnS forming the shell of the resultant Zn/ZnS core-shell composite was clearly observed on the surface of zinc particles (the zinc particle(s) forming the core of the core-shell composite). The presence of sulphur in the shell was further confirmed by SEM-EDX elemental mapping analysis as depicted in FIG. 1B and FIG. 1C. The ZnS shell layer was observed to be thin and mainly amorphous.

### Example 2: Synthesis of Zn/ZnSₓO₁₋ₓ Core-Shell Composite

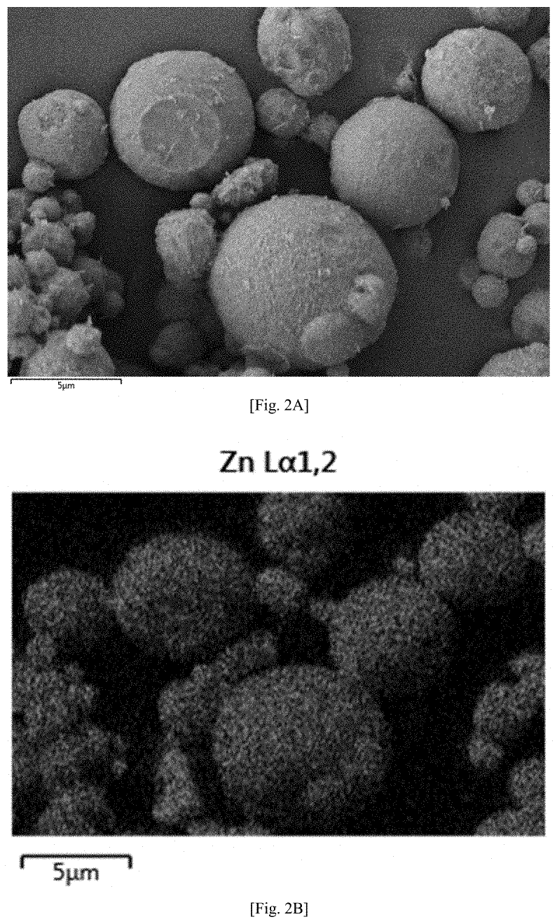

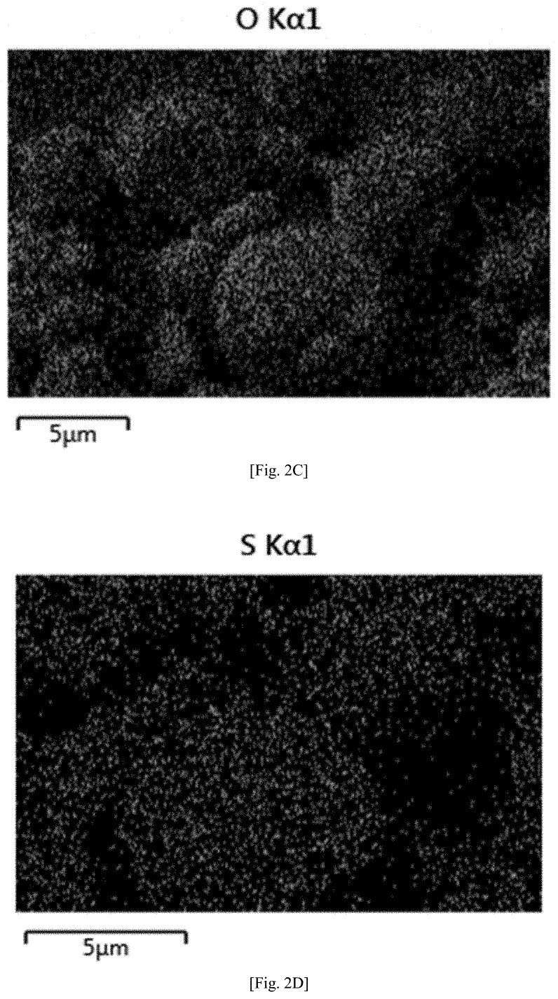

Zn/ZnSₓO₁₋ₓ core-shell composites were prepared by direct reaction between zinc powder and elemental sulphur and water. Fresh zinc powder was mixed with sulphur (0.01 to 20% by weight) and grounded by hand for 10 minutes. The mixture was subsequently heated at a constant temperature between 100 to 160° C. for 1 to 10 hours. After cooling to about 100° C., water was added to the system and temperature was kept at 90 to 110° C. for 1 to 10 hours to produce the Zn/ZnSₓO₁₋ₓ composites. From FIG. 2A, a layer of ZnSₓO₁₋ₓ was clearly observed on the surface of zinc particles (the zinc particle(s) forming the core of the core-shell composite). The presence of S and O in the shell was further confirmed by SEM-EDX elemental mapping analysis as depicted in FIG. 2B, FIG. 2C and FIG. 2D. The ZnSₓO₁₋ₓ shell layer was observed to be mainly amorphous.

### Example 3: Characterization of the Synthesized Core-Shell Composites

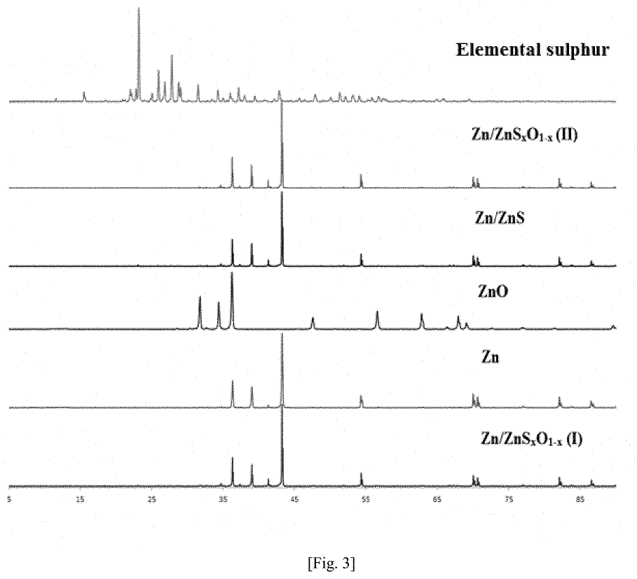

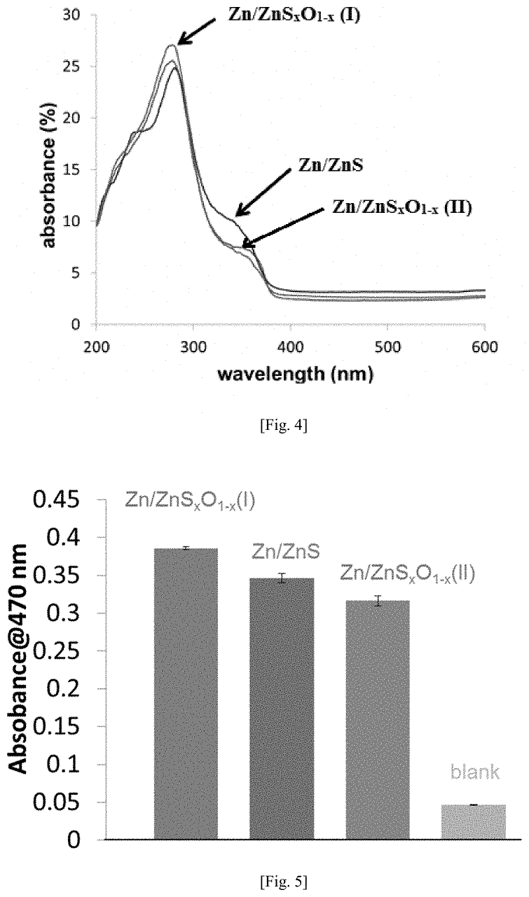

In addition to SEM and SEM-EDX analysis, the synthesized core-shell composites were characterized by XRD and UV-vis spectroscopy. From FIG. 3, the XRD diffraction patterns of the synthesized Zn/ZnS and Zn/ZnSₓO₁₋ₓ composites exhibit strong diffraction peaks related to zinc with very weak ZnO, ZnS and S peaks. In contrast, the UV-vis spectra from FIG. 4 demonstrated different absorption patterns of different core-shell composites. Based on FIG. 3 and FIG. 4, the synthesized core-shell composites possess different compositional and absorption characteristics from other known core-shell materials.

### Example 4: Reactive Oxygen Species Release and Antimicrobial Properties

Reactive oxygen species release, like the superoxide radicals (O₂⁻) level, was studied by using XTT (2,3-Bis-(2-Methoxy-4-Nitro-5-Sulfophenyl)-2H-Tetrazolium-5-Carboxanilide) as probe. 10 mg of the synthesized core-shell composites were weighed out and transferred to micro-centrifuge tubes. 1 mL of 0.1 mM XTT solution was then added to the tubes containing the composites, vortexed and left in the dark at 35° C. for 24 hours. The tubes were then centrifuged, and a 100 μL aliquot was subsequently transferred to a 96-well plate, where absorbance readings at 470 nm were measured. Experiments were performed in triplicates. The results as shown in FIG. 5, clearly demonstrate that Zn/ZnS and Zn/ZnSₓO₁₋ₓ core-shell composites can release higher level of superoxide radicals as compared to the blank which is a control composed of XTT solution only.]

To test the antibacterial properties of these composites, 0.02 g synthesized core-shell composite was dispersed in ethanol, and coated onto a glass slides with a dimension of 2.5 cm×2.5 cm. A blank glass slide used as a control. The antimicrobial properties of the surfaces were evaluated by the JIS Z 2801/ISO 22196 method against E. coli (gram-negative, ATCC 8739) and S. aureus (gram-positive, ATCC 6538P) and C. albicans (fungi). Briefly, 20 mg of core-shell composites were dispersed on pre-cleaned glass slides and an aliquot of microbe (gram positive or gram negative bacteria at concentration of 10⁵ CFU mL⁻¹ or fungi at concentration of 10⁴ CFU mL⁻¹) was introduced onto the slides. Untreated and Zn-coated glass slides were used as negative controls. The slides were incubated for 18 hours at 37° C. and the resultant colony growth on the glass was then washed off with phosphate buffered solution (PBS, 1× concentration), diluted using standard microdilution techniques and counted using standard plate count techniques. The number of colony forming units per mL was calculated and compared against the negative controls, to determine the log reduction and the effective killing efficiency of the core-shell composites. Experiments were done in triplicates. After the 18 hours incubation period, microbial growth was observed on the untreated glass slides such that there was an increase of 2 log units from 10⁵ to 10⁷ CFU mL⁻¹ while for Zn-coated glass slides, there was a minimal reduction of microbial growth at less than 1 log unit from 10⁵ to >10⁴ CFU mL⁻¹. Based on log reduction data (Table 1), surfaces treated with Zn/ZnS, Zn/ZnSₓO₁₋ₓ core-shell composites all showed excellent antimicrobial properties. All tested microbes that were exposed to surfaces with Zn/ZnS, Zn/ZnSₓO₁₋ₓ core-shell composites were killed after an 18 hours incubation period and no colony was observed even at a dilution factor of 10². A 5-log reduction of microbe population was observed for E. coli, S. aureus and C. albicans respectively, exhibiting the excellent antimicrobial properties of Zn/ZnS, Zn/ZnSₓO₁₋ₓ core-shell composites.

TABLE 1
Antimicrobial Properties of Glass Slides Coated
with Different Synthesized Core-Shell Composites

| | log reduction | | |
|---|---|---|---|
| Materials | E. coli | S. aureus | C. albicans |
| Glass control | 0 | 0 | 0 |
| Zn | <1 | <1 | <1 |
| Zn/ZnS | >5 | >5 | >5 |
| Zn/ZnSₓO₁₋ₓ(I) | >5 | >5 | >5 |
| Zn/ZnSₓO₁₋ₓ(II) | >5 | >5 | >5 |

### INDUSTRIAL APPLICABILITY

The core-shell composite may be used as additives that can be incorporated into liquid, gel, emulsion or cream antimicrobial systems. The core-shell material may also be applied as surface coatings to create long-term, self-disinfecting surfaces, inclusive of hard surfaces, fabrics or textiles.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A core-shell composite comprising:
a core comprising zinc metal; and
a shell that at least partially encapsulates said core, said shell comprising a salt of said zinc metal as a cation with a sulphur-containing anion.

2. The core-shell composite of claim 1, wherein said sulphur-containing anion has the formula [SₓO₁₋ₓ]^{y-}, where 0<x≤1 and y is 1 or 2.

3. The core-shell composite of claim 1, wherein said shell comprises a plurality of layers, each layer independently comprising said salt of said zinc metal as a cation with a sulphur-containing anion.

4. A method of forming a core-shell composite comprising a step of heating a mixture of a zinc metal particle with elemental sulphur to form said core-shell composite,
wherein the zinc metal particle forms the core of said core-shell composite,
and wherein the shell of said core-shell composite at least partially encapsulates said core and comprises a salt of said zinc metal as a cation with a sulphur-containing anion.

5. The method of claim 4, further comprising a step of reacting said core-shell composite with an aqueous solution.

6. The method of claim 4, wherein said heating step is undertaken at a temperature in a range of 100° C. to 160° C.

7. The method of claim 4, wherein said heating step is undertaken for a period of time in a range of 1 hour to 10 hours.

8. The method of claim 4, further comprising a step of, before said reacting step, cooling the core-shell composite to a temperature of 100° C.

9. The method of claim 5, wherein said reacting step is undertaken at a temperature in a range of 90° C. to 110° C.

10. The method of claim 5, wherein said reacting step is undertaken for a period of time in a range of 1 hour to 10 hours.

11. The method of claim 5, wherein said aqueous solution is water.

12. A method of killing or inhibiting growth of a microbe, comprising a step of subjecting said microbe to a core-shell composite, wherein said core-shell composite comprises:
a core comprising zinc metal; and
a shell that at least partially encapsulates said core, said shell comprising a salt of said zinc metal as a cation with a sulphur-containing anion.

13. The method of claim 12, wherein said core-shell composite is present as a coating on a substrate surface.

14. The method of claim 12, wherein said core-shell composite is present as an additive in a composition or a formulation.

15. The method of claim 14, wherein said composition or formulation is non-therapeutic.

16.-17. (canceled)
